(19) United States
(12) Patent Application Publication
(10) Pub. No.: US 2020/0324828 A1
(43) Pub. Date: Oct. 15, 2020

(54) VEHICLE BODY WITH REINFORCED FLOOR

(71) Applicants: Hyundai Motor Company, Seoul (KR); Kia Motors Corporation, Seoul (KR)

(72) Inventor: Won Oh Kim, Gwangmyeong (KR)

(21) Appl. No.: 16/567,745

(22) Filed: Sep. 11, 2019

(30) Foreign Application Priority Data
Apr. 11, 2019 (KR) 10-2019-0042696

(51) Int. Cl. B62D 25/20; B62D 25/16

(52) U.S. Cl. CPC B62D 25/2036; B62D 25/16; B62D 25/2027; B62D 25/2018

(57) ABSTRACT

A vehicle body of a vehicle includes: a floor panel, a floor side member coupled to both sides of the floor panel, a front cross member, and a rear cross member, where the floor side member, the front cross member, and the rear cross member are connected to each other to form an annular member structure surrounding an edge of a floor of the vehicle, and the annular member structure forms a load path together with a front side member and a rear side member.

### CROSS REFERENCE TO RELATED APPLICATION

The present application claims under 35 U.S.C. § 119(a) the benefit of Korean Patent Application No. 10-2019-0042696 filed on Apr. 11, 2019, the entire contents of which are incorporated by reference herein.

### BACKGROUND

### (a) Technical Field

The present disclosure relates to a vehicle body of a vehicle with a reinforced floor, more particularly, to the vehicle body having a structure capable of ensuring collision rigidity and preventing deformation of a cabin even when the vehicle is an ultra-compact or a micro vehicle (e.g., a micro-mobility vehicle).

### (b) Description of the Related Art

In the case of an ultra-compact electric vehicle, much demand is expected in the future. Therefore, it is necessary to develop a new vehicle body structure of a vehicle body press welding method considering mass production, rather than the conventional manual production. However, there has been a problem in that in most of the compact vehicles, a sub-frame, etc. are removed but the remaining vehicle body structure is not especially different from the conventional compact vehicle, and thus is not sufficiently rigid to maintain or secure a cabin room upon collision.

In addition, in the case of a micro-mobility vehicle, there is a problem in that it has a design with a short front overhang, such that a front shock absorbing space of the vehicle is small, and it is difficult to maintain an interior space.

Therefore, the vehicle body structure of the vehicle (e.g., micro mobility or personal mobility vehicles) requires a new structure capable of securing torsional rigidity and collision rigidity and maximally preventing deformation of the cabin room.

The foregoing explained as the background is intended merely to aid in the understanding of the background of the present disclosure, and is not intended to mean that the present disclosure falls within the purview of the related art that is already known to those skilled in the art.

### SUMMARY

The present disclosure provides a vehicle body of a vehicle having a reinforced floor structure, in particular, a structure capable of securing collision rigidity and preventing deformation of a cabin even in the case of an ultra-compact vehicle.

A vehicle body of a vehicle according to the present disclosure for achieving the object includes a floor panel having a floor side member coupled to both side ends thereof; a front vehicle body part coupled to the front end portion of the floor panel, having a front cross member prepared on the lower end portion thereof, and having a front side member extending forward from both sides of the front cross member prepared thereon; and a rear vehicle body part coupled to the rear end portion of the floor panel, having a rear cross member prepared on the lower end portion thereof, and having a rear side member extending rearward from both sides of the rear cross member prepared thereon, and the front cross member, the floor side member of both sides, and the rear cross member may be connected to each other to form an annular member structure surrounding the edge of the floor of a vehicle, and the annular member structure may form a load path together with the front side member and the rear side member.

The floor panel may have a flat plate shape and have a high-voltage battery disposed on the lower portion thereof, and the high-voltage battery may have both side ends fastened to the floor side member.

A side chamber inner frame may be coupled to the outside end of the floor side member and a side chamber outer part may be coupled to the side chamber inner frame so that the side end portion of the floor panel has a double-sectional structure.

The front side member may be extended rearward along the lower end of a front wheel house to be connected to the front end of the floor side member.

The rear side member may be extended forward along the lower end of a rear wheel house to be connected to the rear end of the floor side member.

A center cross member crossing in the width direction of the vehicle may be coupled to the upper surface of the floor panel and a center member may be extended forward from both sides of the center cross member to be connected to the front cross member.

A side chamber inner frame may be coupled to the outside end of the floor side member, and the outside end of the center cross member may be coupled to the side chamber inner frame together.

The floor side member may be molded to have a higher strength than that of the side chamber inner frame.

A side surface unit of an annular member shape constituting the edge of a door opening part may be coupled to the side of the floor panel, and the side surface unit may form a cross-sectional structure by constituting a side chamber outer part on the lower end portion thereof and coupling the side chamber outer part to the side chamber inner frame.

According to the vehicle body of the vehicle of the present disclosure, it is possible to have a structure capable of securing the collision rigidity and preventing the deformation of the cabin even in the case of the ultra-compact vehicle.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a diagram illustrating a floor panel of a vehicle body of a vehicle according to an embodiment of the present disclosure.

FIG. 2 is a perspective diagram of the vehicle body of the vehicle according to an embodiment of the present disclosure.

FIG. 3 is a diagram viewing the vehicle body of the vehicle according to an embodiment of the present disclosure from the upward.

FIG. 4 is a cross-sectional diagram of the vehicle body of the vehicle according to an embodiment of the present disclosure.

FIG. 5 is another perspective diagram of the vehicle body of the vehicle according to an embodiment of the present disclosure.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-of”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

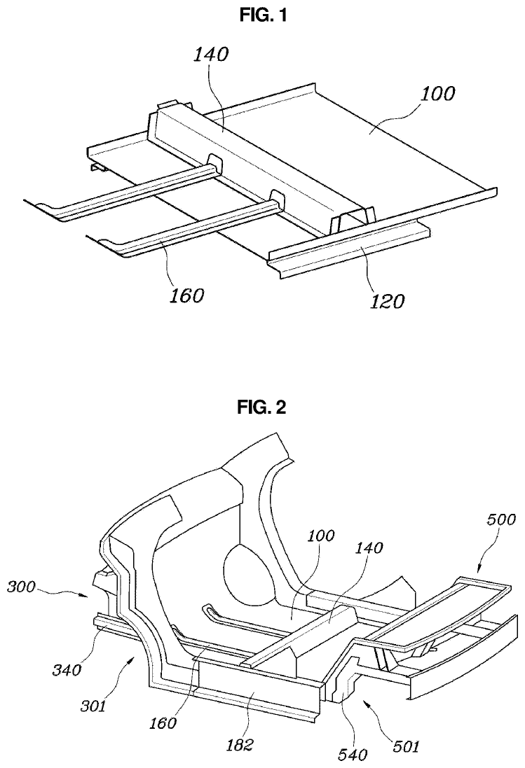

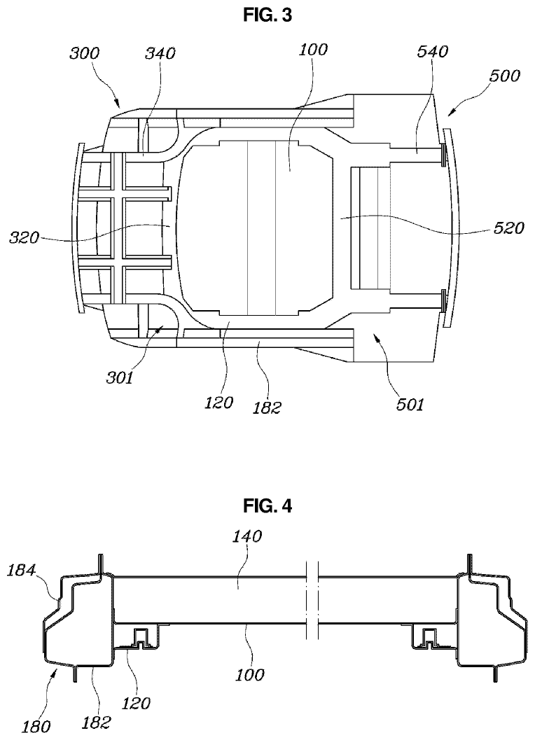

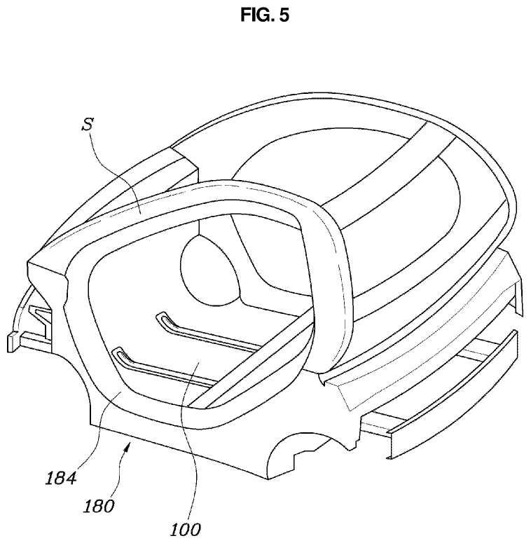

FIG. 1 is a diagram illustrating a floor panel of a vehicle body of a vehicle according to an embodiment of the present disclosure, FIG. 2 is a perspective diagram of the vehicle body of the vehicle according to an embodiment of the present disclosure, FIG. 3 is a diagram viewing the vehicle body of the vehicle according to an embodiment of the present disclosure from the upward, FIG. 4 is a cross-sectional diagram of the vehicle body of the vehicle according to an embodiment of the present disclosure, and FIG. 5 is another perspective diagram of the vehicle body of the vehicle according to an embodiment of the present disclosure.

The present disclosure may be in conjunction with a vehicle having an engine, but preferably is implemented in the case of a vehicle having an ultra-compact vehicle body as an electric vehicle in which the engine is not provided. Since a vehicle (e.g., a micro mobility or a personal mobility vehicle) may be the electric vehicle having a two-seater structure such as a micro-mobility vehicle with an extremely short front overhang, a structure for protecting a passenger seat upon collision is needed.

A conventional vehicle typically includes an engine room in front and is capable of maintaining (i.e., securing) a cabin room even upon collision through a structure such as a sub-frame, but since an ultra-compact vehicle of the present disclosure does not have such a structure, it may be vulnerable to collision. In addition, since such a vehicle is mounted with a high-voltage battery at a lower portion thereof, it is also necessary to protect a battery upon collision.

For this purpose, the present disclosure may secure rigidity of the vehicle and prevent the cabin room from serious damage in the event of a collision through reinforcement and connection of a floor.

Specifically, the vehicle body of the vehicle according to the present disclosure includes a floor panel 100 having a floor side member 120 coupled at both side ends thereof; a front vehicle body part 300 coupled to the front end portion of the floor panel 100, having a front cross member 320 prepared on the lower end portion thereof, and having a front side member 340 extending forward from both sides of the front cross member 320 prepared thereon; and a rear vehicle body part 500 coupled to the rear end portion of the floor panel 100, having a rear cross member 520 prepared on the lower end portion thereof, and having a rear side member 540 extending rearward from both sides of the rear cross member 520 prepared thereon, and the front cross member 320, a floor side member 120 of both sides, and the rear cross member 520 are connected with each other to form an annular member structure surrounding the edge of the floor of the vehicle, and the annular member structure may form a load path together with the front side member 340 and the rear side member 540.

FIG. 1 is a diagram illustrating a floor panel of a vehicle body of a vehicle according to an embodiment of the present disclosure, and FIG. 2 is a perspective diagram of the vehicle body of the vehicle according to an embodiment of the present disclosure.

In the present disclosure, the vehicle body is composed of the floor panel 100, the front vehicle body part 300, and the rear vehicle body part 500, and may be completed by coupling three parts as one vehicle body after the respective parts are manufactured. When such a modular structure is taken, there is an advantage in that it is easy to manufacture the vehicle of various lengths and it is also easy to change the design of the vehicle. In addition, since rigidity of the connection part may be weak in taking the modular structure, the necessary rigidity may be sufficiently secured by applying the concept of the present disclosure.

In particular, the floor panel 100 has the floor side member 120 coupled to both side ends thereof. Specifically, the floor panel 100 may have a flat plate shape and have a high-voltage battery disposed on the lower portion thereof, and the high-voltage battery may have both side ends fastened to the floor side member 120. The battery is mounted on the floor of the flat plate shape, such that the battery may be maximally spaced apart from the ground, and the battery is disposed close to the vehicle body, such that it is easy to design the center of gravity of the vehicle and it is also advantageous to protect the battery.

In addition, it is possible to couple the floor side member 120 to both side ends of the floor panel 100 and install the battery thereon, thereby performing two functions, which mount the battery while reinforcing rigidity, by one member.

In addition, the front vehicle body part 300 is coupled to the front end portion of the floor panel 100, and the rear vehicle body part 500 is coupled to the rear end portion of the floor panel 100. The front vehicle body part 300 has the front cross member 320 prepared at the lower end portion of a dash panel, and has the front side member 340 extending forward from both sides of the front cross member 320 prepared thereon.

Then, the rear vehicle body part 500 is coupled to the rear end portion of the floor panel 100, has the rear cross member 520 prepared on the lower end portion of a partition panel, and has the rear side member 540 extending rearward from both sides of the rear cross member 520 prepared thereon.

Particularly, the front cross member 320, the floor side member 120, and the rear cross member 520 are connected to each other as illustrated in FIG. 3 to form an annular member structure surrounding the edge of the floor of the vehicle, and the annular member structure may form a load path together with the front side member 340 and the rear side member 540.

It is possible to implement the annular member structure along the edge of the floor, thereby securely protecting the cabin room and preventing deformation even if collision occurs in any direction. Then, the annular structure has the front side member 340 prepared at the front side thereof and has the rear side member 540 prepared at the rear side thereof to form the load path capable of effectively dispersing shock through the annular structure even upon the front or the rear collision.

Therefore, when a collision occurs, the side member disperses the shock, and the shock is absorbed by deformation of the front and rear side members 340 and 540, and the annular member structure may robustly absorb the shock and may not be deformed, thereby effectively protecting the cabin room.

A side chamber inner frame 182 is coupled to the outside end of the floor side member 120, and a side chamber outer part 184 is coupled to the side chamber inner frame 182 so that the side end portion of the floor panel 100 may have a double-sectional structure. FIG. 4 is a cross-sectional diagram of the floor panel 100 at a center cross member 140 portion, where the floor side member 120 itself has one cross section, and the side chamber inner frame 182 and the side chamber outer part 184 coupled thereto constitutes one side chamber member 180 so that two sectional structures are connected to each other to have a structure in which they are laterally overlapped.

Therefore, it is possible to secure the collision rigidity of the side of the vehicle. In the case of the front side and the rear side, there is a space occupied by the side members, thereby securing the collision rigidity, but in the case of a side surface portion, there is an insufficient space and no additional member, thereby requiring the double-sectional structure.

Meanwhile, the front side member 340 may be extended rearward along the lower end of a front wheel house 301 to be connected to the front end of the floor side member 120. Then, the rear side member 540 may be extended forward along the lower end of a rear wheel house 501 to be connected to the rear end of the floor side member 120. Therefore, the load path may be formed by using a configuration such as the wheel house even without additionally securing the space, and the load path, which has been connected while manufacturing the vehicle body by modularizing three components of the front vehicle body part 300, the floor panel 100, and the rear vehicle body part 500, may be easily formed.

In addition, as in FIGS. 1 and 2, the center cross member 140 crossing in the width direction of the vehicle may be coupled to the upper surface of the floor panel 100 and a center member 160 may be extended forward from both sides of the center cross member 140 to be connected to the front cross member 320. Therefore, it is possible to provide additional rigidity to the center portion of the vehicle.

In addition, the side chamber inner frame 182 may be coupled to the outside end of the floor side member 120, and the outside end of the center cross member 140 may be coupled to the side chamber inner frame 182 together as in FIG. 4. Then, the floor side member 120 may be molded to have a higher strength than that of the side chamber inner frame 182.

Specifically, as shown in FIG. 5, a side surface unit S of an annular member shape constituting the edge of a door opening part is coupled to the side of the floor panel 100, and the side surface unit S may form a cross-sectional structure by constituting the side chamber outer part 184 on the lower end portion thereof, and coupling the side chamber outer part 184 to the side chamber inner frame 182.

The vehicle body of the present disclosure molds a basic vehicle body through three modules, and additionally couples the side surface unit thereto. In the case of the present embodiment of two-seater structure, the vehicle body of the present disclosure couples the side surface unit S of the annular shape along the edge of the opening part in which a door is installed, such that this is also advantageous if the collision rigidity and the torsional rigidity are secured through the annular structure.

Then, the cross-sectional structure is formed by constituting the side chamber outer part 184 on the lower end portion of the side surface unit S, and coupling the side chamber outer part 184 to the side chamber inner frame 182 to constitute the side chamber member 180 so that the side end portion of the floor panel 100 has the double-sectional structure.

Then, the floor side member 120 is molded to have a higher strength than that of the side chamber inner frame 182 to absorb the shock by the deformation of the side chamber member 180 and prevent the deformation and support in the floor side member 120, thereby securing rigidity of the cabin room and minimizing shock transmission.

In addition, as in FIG. 4, the side chamber member 180 is also connected to the center cross member 140, thereby securing the lateral collision rigidity more robustly. For this purpose, the height of the side chamber inner frame 182 should be designed to be at least equal to or greater than the sum of the height of the center cross member 140 and the floor side member 120.

The present disclosure may disperse the shock well upon collision through the above-described vehicle body structure and ensure the necessary rigidity of the cabin room. Particularly, the side surface portion may secure the necessary rigidity while effectively absorbing the shock through the double-sectional structure and differentiation of the rigidity, thereby securing the effective collision rigidity and torsional rigidity even in the case of the ultra-compact vehicle or a vehicle having a short front overhang.

While it has been illustrated and described with respect to the specific embodiments of the present disclosure, it will be understood by those skilled in the art that various improvements and changes of the present disclosure may be made within the technical spirit of the present disclosure as provided by the following claims.

what is claimed is:

1. A vehicle body of a vehicle, comprising:
a floor panel having a floor side member coupled to both side ends thereof;
a front vehicle body part coupled to a front end portion of the floor panel, the front vehicle body part having a front cross member prepared on a lower end portion thereof, and a front side member extending forward from both sides of the front cross member prepared thereon; and
a rear vehicle body part coupled to a rear end portion of the floor panel, the rear vehicle body part having a rear cross member prepared on a lower end portion thereof, and a rear side member extending rearward from both sides of the rear cross member prepared thereon,
wherein the front cross member, the floor side member, and the rear cross member are connected to each other to form an annular member structure surrounding an edge of a floor of the vehicle, and the annular member structure forms a load path together with the front side member and the rear side member.

2. The vehicle body of the vehicle according to claim 1,
wherein the floor panel has a flat plate shape and has a high-voltage battery disposed on a lower portion thereof, and the high-voltage battery has both side ends fastened to the floor side member.

3. The vehicle body of the vehicle according to claim 1,
wherein a side chamber inner frame is coupled to an outside end of the floor side member, and a side chamber outer part is coupled to the side chamber inner frame so that a side end portion of the floor panel has a double-sectional structure.

4. The vehicle body of the vehicle according to claim 1,
wherein the front side member is extended rearward along a lower end of a front wheel house to be connected to a front end of the floor side member.

5. The vehicle body of the vehicle according to claim 1,
wherein the rear side member is extended forward along a lower end of a rear wheel house to be connected to a rear end of the floor side member.

6. The vehicle body of the vehicle according to claim 1,
wherein a center cross member crossing in a width direction of the vehicle is coupled to an upper surface of the floor panel, and a center member is extended forward from both sides of the center cross member to be connected to the front cross member.

7. The vehicle body of the vehicle according to claim 6,
wherein a side chamber inner frame is coupled to an outside end of the floor side member, and an outside end of the center cross member is coupled to the side chamber inner frame together.

8. The vehicle body of the vehicle according to claim 7,
wherein the floor side member is molded to have a higher strength than that of the side chamber inner frame.

9. The vehicle body of the vehicle according to claim 7,
wherein a side surface unit of an annular member shape constituting an edge of a door opening part is coupled to a side of the floor panel, and the side surface unit forms a cross-sectional structure by constituting a side chamber outer part on a lower end portion thereof and coupling the side chamber outer part to the side chamber inner frame.
